(19) United States
(12) Patent Application Publication
(10) Pub. No.: US 2014/0260439 A1
(43) Pub. Date: Sep. 18, 2014

(54) MOTORCYCLE LOCKING DEVICES

(71) Applicant: Patrick Dallaire, Portland, OR (US)

(72) Inventor: Patrick Dallaire, Portland, OR (US)

(21) Appl. No.: 14/212,953

(22) Filed: Mar. 14, 2014

Related U.S. Application Data
(60) Provisional application No. 61/784,241, filed on Mar. 14, 2013.

(51) Int. Cl. B62H 5/00

(52) U.S. Cl. CPC B62H 5/00
USPC 70/15

(57) ABSTRACT

Disclosed herein are locking devices for securing a motorcycle by holding or clamping a brake lever toward the throttle such that operation of the motorcycle is impaired. Disclosed locking devices include a first rigid arm with a female locking mechanism at one end and a second rigid arm pivotably coupled to the opposite end and having an male engagement portion with a plurality of notches that is insertable into and lockable with the female locking mechanism. The device has an open position wherein the first and second arms are pivoted away from each other such that device is positionable around a throttle and a brake lever of a motorcycle. The locking device also has a closed position wherein the engagement portion of the second arm is inserted into the female locking mechanism such that the device holds the brake lever toward the throttle such that a brake of the motorcycle is engaged and the motorcycle is restricted from rolling. A motion sensor system can also be included.

### CROSS REFERENCE TO RELATED APPLICATION

This application claims the benefit of U.S. Provisional Application No. 61/784,241, filed on Mar. 14, 2013, which is hereby incorporated by reference in its entirety.

### FIELD

This application is related to motorcycles, and particularly to devices for engaging the throttle and/or a brake lever of a motorcycle to deter theft.

### SUMMARY

Disclosed herein are various embodiments of locking devices for securing a motorcycle by holding or clamping a brake lever toward the throttle such that operation of the motorcycle is impaired.

Disclosed locking devices can include a first rigid arm with a female locking mechanism at one end and a second rigid arm pivotably coupled to the opposite end. The second arm can have a male engagement portion having a plurality of notches that is insertable into and lockable with the female locking mechanism. The device has an open position wherein the first and second arms are pivoted away from each other such that the engagement portion of the second arm is spaced apart from the locking mechanism and the device is positionable around a throttle and a brake lever of a motorcycle. The locking device also has a closed position wherein the first and second arms are pivoted toward each other such that the engagement portion of the second arm is inserted into the female locking mechanism, which engages with at least one of the notches to secure the locking device in the closed position.

The locking device is adapted to extend around the brake lever and the throttle of the motorcycle in the closed position and to hold the brake lever in an engaged position toward the throttle such that a brake of the motorcycle is engaged and the motorcycle is restricted from rolling. The first arm can also frictionally engage with the throttle such that rotation of the throttle is substantially restricted. Portions of the first arm and/or the second arm can be covered with a material that creates an anti-slip engagement with the throttle and/or the brake lever when the device is in the closed position around the throttle and brake lever, to prevent rotation of the throttle and prevent the device from being slid off of the throttle and brake lever.

The locking device can comprise a ratcheting mechanism that allows the engagement portion of the second arm to enter and move further into the female locking mechanism but does not allow the engagement portion of the second arm to be moved out of the female locking mechanism. The locking mechanism can be user-actuated in various ways, such by use of a removable key or a combination lock. Actuation by the user cause the second arm to be released from the first arm so that the device can be removed from the motorcycle.

In some embodiments, the ratcheting mechanism comprises a rocker that is pivotable relative to a housing of the female locking mechanism between an engaged position, wherein the rocker engages one of the notches to prevent the engagement portion of the second arm from moving out of the lock, and a disengaged position wherein the engagement portion of the second arm is free to pivot out of the lock, and wherein the rocker is biased toward the engaged position. User actuation of the lock causes the rocker arm to be held in the disengaged position in order to open the device and remove it from a motorcycle.

The arms of the device can be have flattened or rounded inner surfaces that contact the throttle and/or the brake lever.

In some embodiments, the locking device can also include a motion sensor that detects motion of the motorcycle. The locking device can also include a battery coupled to the sensor and/or a wireless transmitter coupled to the sensor that generates a wireless signal to a remote receiver, such as the bike owner's mobile phone. The remote receiver can include an application or software that generates an alarm and/or another indication that motion has been sensed. In some systems, police or other entities can be notified automatically if motion is detected. The locking device can also include an alarm that goes off if motion is detected to help deter theft.

The foregoing and other objects, features, and advantages of the disclosed technology will become more apparent from the following detailed description, which proceeds with reference to the accompanying figures.

### BRIEF DESCRIPTION OF THE FIGURES

FIG. 1 shows an exemplary locking device for securing a motorcycle.

FIG. 1A shows another exemplary locking device for securing a motorcycle.

FIG. 1B shows yet another exemplary locking device for securing a motorcycle.

FIG. 2 is a side cross-section view of a locking portion of the device of FIG. 1.

FIG. 2A is a side cross-sectional view of a locking portion of the device of FIG. 1A.

FIG. 2B is a top cross-sectional view of a locking portion of the device of FIG. 1A.

FIG. 2C is a side view of a locking portion of the device of FIG. 1B.

FIG. 2D is a top view of a locking portion of the device of FIG. 1B.

FIGS. 3A, 4A, 5A, and 6A are cross-sectional views of the device of FIG. 1.

FIGS. 7A and 8A are top cross-sectional views of the locking portion of the device of FIG. 1, in engaged and disengaged positions, respectively.

FIGS. 3B, 4B, 5B, 6B and 7B are cross-sectional views of the device of FIG. 1B.

FIGS. 3C, 4C, 5C, 6C and 7C are cross-sectional views of an alternative embodiment of the device of FIG. 1B.

FIG. 9 shows the device of FIG. 1 engaged around a motorcycle throttle and brake lever.

FIG. 10 shows another exemplary locking device for securing a motorcycle having a motion detector.

### DETAILED DESCRIPTION

Disclosed herein are various embodiments of locking devices for securing a motorcycle by holding a brake lever toward the throttle such that operation of the motorcycle is impaired and theft is deterred. Different exemplary embodiments are shown in FIGS. 1, 1A, and 1B. FIG. 1 shows a locking device 10 that includes a key-based lock 20, FIG. 1A shows a locking device 30 that includes an alternative key-based lock 32, and FIG. 1B shows a locking device 50 that includes a combination lock, or dial-based lock, 52. The locking devices 10, 30, 50 are configured to deter the theft of a motorcycle, among other uses.

As shown in FIG. 9, any of the disclosed locking devices (embodiment 10 is shown as an example) can be placed around the hand throttle 100 and the front brake lever 110 of a motorcycle. When the locking device is placed around the hand throttle 100 and the front brake lever 110 of the motorcycle, the front brake lever is pulled in as if applying the front break to stop the motorcycle. At this point, the locking device is cinched tight to retain the brake lever 110 in the locked position. When the locking device is in the locked position, the motorcycle cannot be rolled away because the front brake is engaged and the throttle becomes useless for operating the motorcycle.

Some embodiments of the locking device comprise a combination lock (e.g., FIG. 1B), some embodiments comprise a keyed lock (e.g., FIGS. 1 and 1A), and some embodiments comprise a special shaped male key (e.g., FIGS. 7A and 8A). Each can serve the same purpose, which is to secure the locking device in place as it secures pressure on the brake lever 110 and throttle 100. The lock of the locking device can be integrated into the female portion of the locking device.

As shown in FIG. 1, the device 10 comprises a female arm 12, a male arm 14 pivotably coupled to the female arm, a serrated or notched engagement portion 16 on the male arm, and the lock 20 mounted on the female arm. A key 22 for the lock 20 is also shown. In an open position, the male arm 14 pivots away from the female arm 12 to provide enough space therebetween for the locking device to be placed over a throttle and brake lever. The female and male arms 12, 14 are then pivoted toward each other such that the engagement portion 16 moves into a cavity in the female arm and engages with the lock 20 to prevent the two arms from pivoting back apart from each other. The pivot hinge between the two arms can be pinned together with a high strength rivet, pivot pin, or other fastener.

As shown in FIGS. 2, 7A, and 8A, the lock 20 can include a ratcheting mechanism, such as including rocker 26, that engages with the notches in the engagement portion 16 to allow further relative motion between the two arms in the closing direction but prevent relative motion in the opening direction. FIGS. 3A and 4A show cross-sectional views of the lock 20 engaged with the engagement portion 16 of the male arm 14. The user can operate the lock 20 by twisting the key 22 to drive an actuator 28 that pushes a lever arm 29 of the rocker 26 and pivots the rocker to a disengaged position (see dashed lines in FIG. 2, and FIG. 8A), which allows the male arm 14 to pivot away from the female arm 12 and open the device 10. The rocker 26 can be spring biased toward the engaged position (see solid lines in FIG. 2, and FIG. 7A) such that the rocker engages the notches in the engagement portion 16 of the male arm 14 when the key 22 is turned to the locked position causing the actuator 28 to move back away from the rocker and allow the rocker to freely toggle. In the locked position, the key 22 can be removed for security.

As shown in FIG. 1A, the device 30 includes the female arm 12, the male arm 14 pivotably coupled to the female arm, the serrated or notched engagement portion 16 on the male arm, and an alternative key-based lock 32 mounted on the female arm 12. A key 34 for the lock 30 is also shown. As shown in FIGS. 2A and 2B, the lock 32 can include a ratcheting mechanism, such as including rocker 36, that engages with the notches in the engagement portion 16 to allow further relative motion between the two arms in the closing direction but prevent relative motion in the opening direction. The user can operate the lock 32 by twisting the key 34 to drive an actuator that pushes the rocker 36 to a disengaged position (see dashed lines in FIG. 2A), which allows the male arm 14 to pivot away from the female arm 12 and open the device 10. The rocker 36 can be spring biased toward the engaged position (see solid lines in FIG. 2A) such that the rocker engages the notches in the engagement portion 16 of the male arm 14 when the key 32 is turned to the locked position, allowing the rocker 36 to freely toggle. In the locked position, the key 32 can be removed for security.

As shown in FIG. 1B, the device 50 includes the female arm 12, the male arm 14 pivotably coupled to the female arm, the serrated or notched engagement portion 16 on the male arm, and a combination lock 52 mounted on the female arm 12. As shown in FIGS. 2C and 2D, the lock 52 can include a ratcheting mechanism, such as including rocker 58, that engages with the notches in the engagement portion 16 to allow further relative motion between the two arms in the closing direction but prevent relative motion in the opening direction. FIGS. 3B and 4B show cross-sectional views of the lock 52 with the engagement portion 16 engaged, and show cross-sectional views of a number wheel 54 and the actuator 56. FIG. 5B is a cross-sectional view of the female arm 12 with the engagement portion 16 of the male arm 14 inserted into female arm. FIGS. 6B and 7B show cross-sectional views of the female and male arms 12, 14. FIGS. 3C, 4C, 5C, 6C, and 7C shows the same cross-sectional views as FIGS. 3B, 4B, 5B, 6B and 7B, but for a version of the device 50 wherein the arms 12, 14 have flattened cross-sectional profiles.

From the locked position, the user can rotate the number wheels 54 to a preset combination to unlock the actuator 56, which can then slide toward the rocker 58 to push a lever arm 59 of the rocker to a disengaged position (see dotted lines in FIG. 2C), which allows the male arm 14 to pivot away from the female arm 12 and open the device 50. The rocker 58 can be spring biased toward the engaged position (see solid lines in FIG. 2C) such that the rocker engages the notches in the engagement portion 16 of the male arm 14 when the actuator is moved away from the rocker in the locked position, allowing the rocker 58 to freely toggle. In the locked position, the number wheels 54 can be rotated to a random setting to keep the lock secured.

The locking devices disclosed herein can have a non-circular overall shape, such as a generally oval shape, when viewed from the side (e.g., the view of FIG. 1), which can facilitate clamping the throttle and front break lever together in one motion when the locking device is closed.

The locking devices disclosed herein can be constructed partially or completely of any of various metals, such as aluminum, titanium, and/or steel, carbon fiber reinforced composite materials, polymeric materials, and/or other sufficiently strong and durable materials.

At least portions of the female and male arms 12, 14 of the disclose devices can have a generally cylindrical or circular cross-sectional shapes (as shown in FIGS. 5B, 6B, and 7B), or a generally flattened cross-sectional shape (as shown in FIGS. 5A, 6A, 5C, 6C, and 7C), or other suitable cross-sectional shape. These configurations can be formed by constructing the arms from cylindrical stock metal or from flat sheet metal, for example.

Any of the locking devices disclosed herein can optionally also include a covering or coating around one or more portions of the device to provide scratch resistance when applied to a motorcycle, anti-slip/anti-skid traction when in contact with the throttle and brake lever, grip for the user, user comfort, aesthetics, and/or other benefits. An exemplary covering 24 is shown in FIGS. 1 and 9 positioned on portions of the female arm 12 and the male arm 14. The covering can comprise a polymeric material, rubber, foam, leather, paint, and/or other materials, and be secured via friction, adhesive, weld, and/or other means. As shown in FIG. 9, once locked into place, the rubber-to-rubber contact (for example) between the throttle 100 and the covering 24 and the knob that is located at the end the motorcycle brake lever 110 can prevent a would-be thief from sliding the lock 10 off to release the brake. FIGS. 5A and 6A shows cross-sections of the arms 12, 14 that illustrate the covering 24.

Any of the locking devices disclosed here can optionally also include a motion detector that can detect motion of the motorcycle when the device is secured to the motorcycle. The motion detector can be encased into, or otherwise coupled to, the arms or lock of the device. The motion detector can be part of a system that includes a battery or other power supply, a recharging port, a sensor that detects motion, and a transmitter that sends a wireless signal indicating sensed motion. The power supply can be rechargeable, such as via a USB cable or other wired charger. Sound and/or light emitting alarm devices can also be included in or coupled to the motion detector to further deter theft.

An exemplary locking device 60, similar to the locking device 50, having a motion detector 62 is shown in FIG. 10. In this example, the motion detector 60 is located in the adjacent to the locking mechanism and built into the housing. In other embodiments, the motion detector can be located elsewhere on the device. The motion detector 60 can comprise a circuit board that includes a low-power consumption motion sensor, a transmitter, and an onboard power supply circuit. The motion detector 62 can be coupled to a micro USB port 64 such that a user can recharge the motion detector 60 by plugging in a micro USB cable into the port 64.

The wireless signal can be transmitted in any form, such as using Bluetooth technology, and can be received by a remote receiver. The receiver can be a mobile computing device, such as a cell phone, tablet, laptop, pager, etc., or a stationary device. The receiver can be coupled or paired to the transmitter such that only signals from a particular transmitter are received by a particular receiver. The receiver can include an application or other software program that generates an alarm or other signal to indicate that the motorcycle has been moved. The receiver can be a mobile phone or the like and the user can download or otherwise install the application or software that specifically allows the user to pair that particular mobile device to a particular locking device, such as using Bluetooth or similar technology. The transmitter can optionally also send a signal to a central monitoring station that monitors many different locking devices, and/or send a signal to police or other authorities to help prevent theft, or interrupt or catch a thief.

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means physically or electrically coupled or linked and does not exclude the presence of intermediate elements between the coupled or associated items absent specific contrary language.

Unless otherwise indicated, all numbers expressing properties, sizes, percentages, measurements, distances, ratios, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, numbers are not approximations unless the word “about” is recited.

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims. We therefore claim all that comes within the scope of the following claims.

1. A locking device for securing a motorcycle, comprising:
a first rigid arm having a first end and a second end;
a lock at the first end of the first rigid arm; and
a second rigid arm having a first end and a second end, the second end of the second rigid arm being pivotably attached to the second end of the first rigid arm, and the first end of the second rigid arm comprising an engagement portion having a plurality of notches;
wherein the locking device has an open position wherein the first and second arms are pivoted away from each other such that the engagement portion of the second arm is spaced apart from the lock and the locking device is positionable around a throttle and a brake lever of a motorcycle;
wherein the locking device has a closed position wherein the first and second arms are pivoted toward each other such that the engagement portion of the second arm is inserted into a female portion of the lock and the lock engages with at least one of the notches to secure the locking device in the closed position;
wherein in the closed position, the locking device is adapted to extend around the brake lever and the throttle of the motorcycle and hold the brake lever in an engaged position toward the throttle such that a brake of the motorcycle is engaged and the motorcycle is restricted from rolling.

2. The device of claim 1, wherein in the closed position, the first arm is adapted to frictionally engage with the throttle such that rotation of the throttle is substantially restricted.

3. The device of claim 1, wherein at least a portion of the first arm is covered with a material that creates an anti-slip engagement with the throttle when the device is in the closed position around the throttle and brake lever.

4. The device of claim 1, wherein the lock comprises a ratcheting mechanism that allows the engagement portion of the second arm to enter and move further into the lock but does not allow the engagement portion of the second arm to be moved out of the lock.

5. The device of claim 1, wherein the lock is a key-based lock, wherein user actuation of a key within the lock releases the engagement portion of the second arm from the lock.

6. The device of claim 1, wherein the lock is a combination lock, wherein user rotation of a plurality of number wheels of the lock to a preset combination releases the engagement portion of the second arm from the lock.

7. The device of claim 4, wherein the ratcheting mechanism comprises a rocker that is pivotable relative to a housing of the lock between an engaged position, wherein the rocker engages one of the notches to prevent the engagement portion of the second arm from moving out of the lock, and a disengaged position wherein the engagement portion of the second arm is free to pivot out of the lock, and wherein the rocker is biased toward the engaged position.

8. The device of claim 7, wherein user actuation of the lock causes the rocker arm to be held in the disengaged position in order to open the device and remove it from a motorcycle.

9. The device of claim 1, wherein the first arm and the second arm have a flat inner contact surface for contacting the throttle and brake lever.

10. The device of claim 1, wherein the first and second arms are arcuate.

11. The device of claim 1, wherein the first and second arms are hinged together at a point about opposite from the engagement between the lock and the notches.

12. The device of claim 1, wherein the first and second arms can pivot at least 180° relative to each other.

13. The device of claim 1, wherein the first arm includes a channel extending through the first arm and having a first opening for receiving the second arm and having a second opening through which a free end of the second arm can project when in the closed position.

14. A locking device for placement around a throttle and a brake lever of a motorcycle to secure the motorcycle, locking device comprising:
first and second rigid arms that are pivotably coupled together and configured to be closed around the throttle and brake lever;
a female portion of a lock on the first rigid arm; and
a male portion of the lock on the second rigid arm;
wherein the locking device has an open position wherein the first and second arms are pivoted away from each other such that the locking device is positionable around the throttle and the brake lever;
wherein the locking device has a closed position wherein male portion of the lock on the second arm is inserted into the female portion of the lock on the first arm and the lock prevents the first and second arms from pivoting apart from each other; and
wherein in the closed position, the locking device is adapted to clamp the brake lever in an engaged position toward the throttle such that a brake of the motorcycle is engaged and the motorcycle is restricted from rolling.

15. The device of claim 14, wherein the lock comprises a ratcheting interface between notches in the male portion and a rocker of the female portion that allows the male portion to enter and move further into the female portion but prevents the male portion from moving out of the lock unless a user selectively releases the lock.

16. The device of claim 15, wherein the rocker is pivotable relative to a housing of the female portion of the lock between an engaged position, wherein the rocker engages the notches in the male portion, and a disengaged position wherein the rocker is not engaged with the notches so that the second arm is free to pivot away from the first arm.

17. The device of claim 16, wherein the rocker is spring biased to the engaged position and user actuation of the lock causes the rocker arm to be held in the disengaged position.
